(19) United States
(12) Patent Application Publication
(10) Pub. No.: US 2005/0068681 A1
(43) Pub. Date: Mar. 31, 2005

(54) Method and system of partial potting head slider to head suspension

(76) Inventors: Ming Gao Yao, Dongguan City (CN); Masashi Shiraishi, Kowloon (HK)

Correspondence Address: KENYON & KENYON, Suite 600, 333 N. San Carlos Street, San Jose, CA, 95110-2711, US

(21) Appl. No.: 10/808,149

(22) Filed: Mar. 24, 2004

(30) Foreign Application Priority Data
Sep. 27, 2003 (WO) PCT/CN03/00824

(51) Int. Cl. G11B 5/60

(52) U.S. Cl. 360/234.6

(57) ABSTRACT

A system and method are disclosed using a formed slider fixture to reduce the amount of adhesive or epoxy needed to couple a slider to a suspension. The adhesive is applied to the slider fixture or to the slider before coupling. In one embodiment, the slider fixture has a side forming plates on both edge sides of the slider. In one embodiment, the slider fixture has a third forming plate on the third side of the slider.

### BACKGROUND INFORMATION

The present invention is directed to attaching a slider to a head suspension. More specifically, the present invention pertains to reducing the amount of adhesive needed to couple the slider to the head suspension.

FIG. 1 illustrates a hard disk drive design typical in the art. Hard disk drives 100 are common information storage devices consisting essentially of a series of rotatable disks 104 that are accessed by magnetic reading and writing elements. These data transferring elements, commonly known as transducers, are typically carried by and embedded in a slider body 110 that is held in a close relative position by a suspension attached to an actuator arm 102 over discrete data tracks formed on a disk to permit a read or write operation to be carried out. In order to properly position the transducer with respect to the disk surface, an air bearing surface (ABS) formed on the slider body 110 experiences a fluid air flow that provides sufficient lift force to “fly” the slider 110 (and transducer) above the disk data tracks. The high speed rotation of a magnetic disk 104 generates a stream of air flow or wind along its surface in a direction substantially parallel to the tangential velocity of the disk. The air flow cooperates with the ABS of the slider body 110 which enables the slider to fly above the spinning disk. In effect, the suspended slider 110 is physically separated from the disk surface 104 through this self-actuating air bearing. The ABS of a slider 110 is generally configured on the slider surface facing the rotating disk 104 (see below), and greatly influences its ability to fly over the disk under various conditions.

FIGS. 2a-c illustrates a prior art method for coupling a slider 110 to the suspension of an actuator arm 102. As shown in FIG. 2a, a slider fixture 202 is coupled parallel to a suspension 204 at the head end of the actuator arm 102. The slider fixture 202 is connected to a set of pads 206 upon which epoxy or a different adhesive is affixed. A polyimide pattern 208 surrounds the adhesive pads 206 to prevent overflow. A set of electrical suspension bonding pads 210 is electrically coupled to a set of traces 212 that allow the read/write head of the slider to be electrically coupled to a controller. As shown in FIG. 2b, adhesive 214 is potted at the adhesive pads 206. The slider 110 is affixed to the slider fixture 202 so that the electrical slider bonding pads 216, allowing electrical access to the read/write head, is lined up with the electrical suspension bonding pads 210. As shown in FIG. 2c, the electrical slider bonding pads 216 and the electrical suspension bonding pads 210 is electrically coupled by soldering 218.

The described procedure impacts the head gimbal assembly (HGA) dynamic and static characteristics. Additionally, since the epoxy or adhesive has a different Young modulus than the other materials of the HGA, it will shrink or extend as the ambient temperature changes, such as during the curing process. The traditional mounting method of full potting between the slider and the slider fixture can easily change the slider profile, such as the crown, twist, or camber of the head. Using less epoxy or adhesive volume will effect the bonding strength, possibly allowing the slider to separate from the slider fixture. Too much epoxy or adhesive volume can lead to contamination of the surrounding apparatus.

### BRIEF DESCRIPTION OF THE DRAWINGS

FIG. 1 illustrates a hard disk drive design typical in the art.

FIGS. 2a-c illustrates a prior art method for coupling a slider to the suspension of an actuator arm.

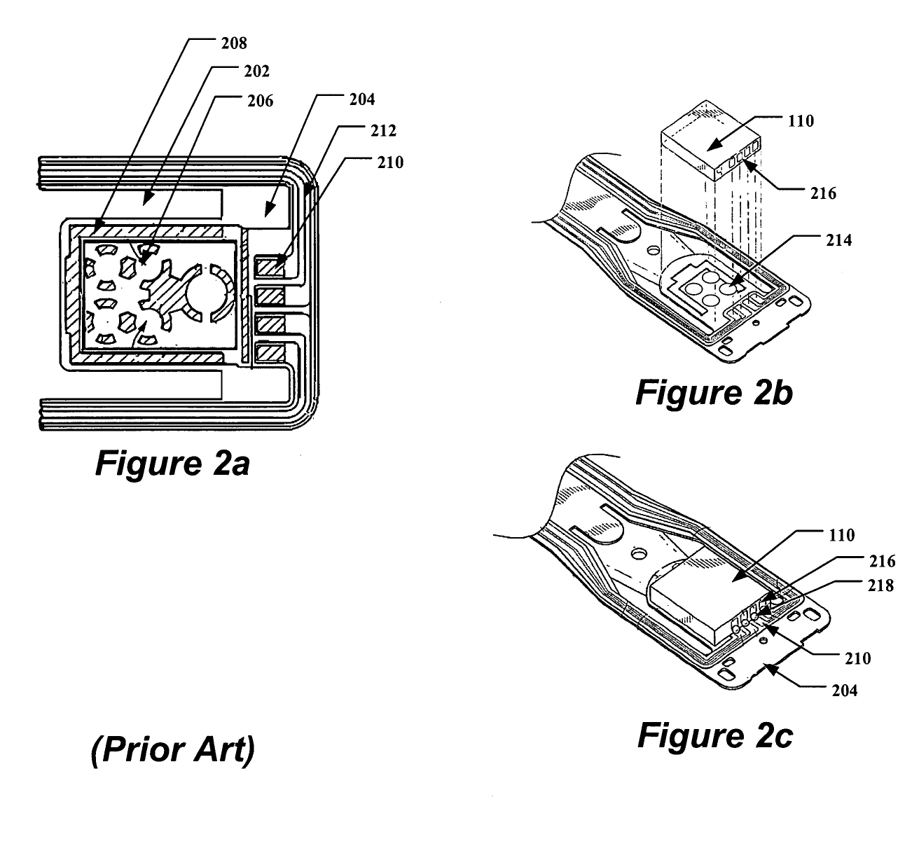

FIGS. 3a-c illustrate a first formed slider fixture according to embodiments of the present invention.

FIG. 4 illustrates alternate embodiments for creating the formed slider fixture according to the present invention.

FIGS. 5a-c illustrate a second formed slider fixture according to embodiments of the present invention.

FIGS. 6a-b illustrate a third formed slider fixture according to embodiments of the present invention.

FIGS. 7a-b illustrate a fourth formed slider fixture according to embodiments of the present invention.

FIGS. 8a-b illustrate a fifth formed slider fixture according to embodiments of the present invention.

FIGS. 9a-b illustrate a sixth formed slider fixture according to embodiments of the present invention.

FIGS. 10a-b illustrate in a graph the testing result of the HGA profile change between partial potting and full potting.

### DETAILED DESCRIPTION

A system and method are disclosed using a formed slider fixture to reduce the amount of adhesive or epoxy needed to couple a slider to a suspension. In this embodiment, the adhesive is applied to the slider fixture or to the slider before coupling. Other methods of coupling besides adhesive may also be used. By redistributing the points of coupling between the slider and the slider fixture, less strain is placed on the coupling points so that less adhesive is needed. Different shapes for the formed slider fixture may be used based on what best supports the slider using the least amount of adhesive. Examples of some, but by no means all, of these shapes can be found in the following descriptions.

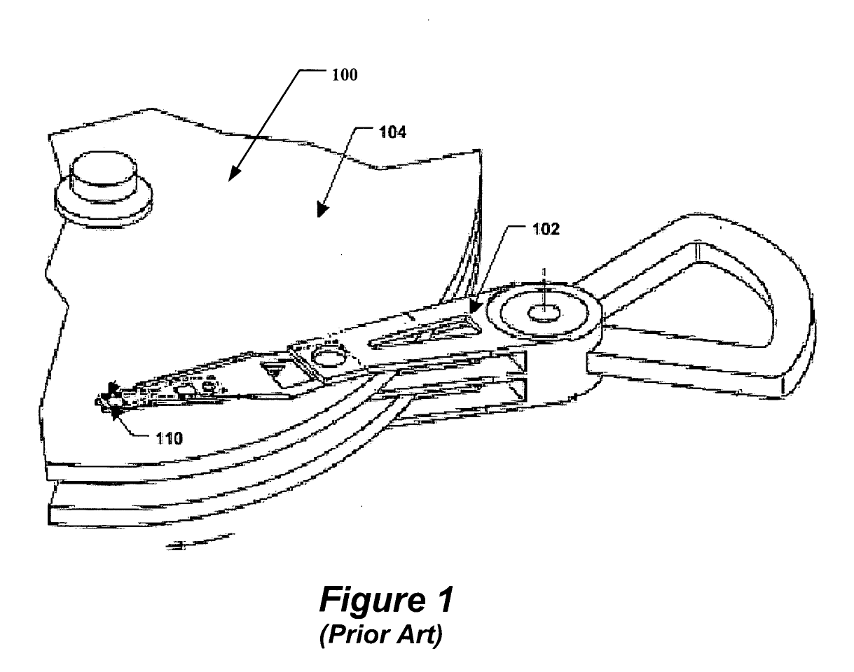

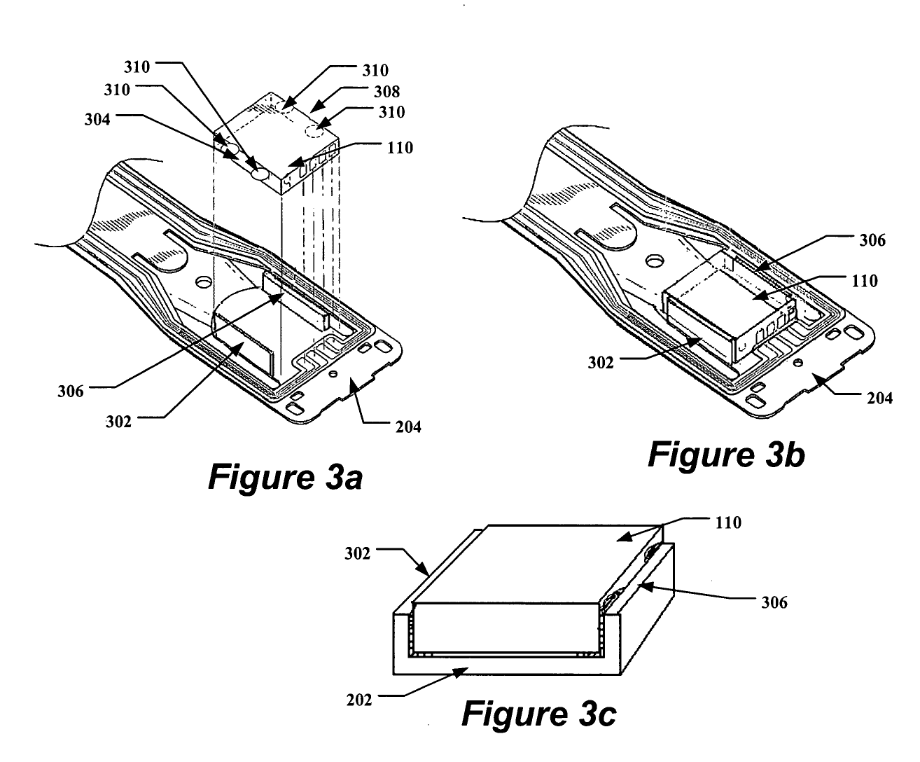

FIGS. 3a-c illustrate one embodiment of a formed slider fixture. The slider fixture allows a slider to be coupled to the actuator arm of a hard disk drive, such as the hard disk drive shown in FIG. 1 and described above. As shown in FIG. 3a, a slider fixture 202 has a first side forming plate 302 formed to cover a first side surface 304 of the slider 110. A second side forming plate 306 is formed to cover a second side surface 308 of the slider 110. For the purposes of this description, a forming plate covers a surface when the plate covers the surface for the entire horizontal length of the surface, as first side forming plate 302 covers first side surface 304 in FIG. 3. The forming plate need not cover the surface for the entire vertical length in order to cover the surface. Two partial dots 310 of adhesive are applied to the first side surface 304 and second side surface 308 of the slider 110. In one embodiment, instead of two partial dots, a bar-shaped strip of adhesive is placed on the first side surface 304 and the second side surface 308 of the slider 110. The adhesive is an epoxy or a different adhesive material. In the example shown in FIG. 3b, the slider 110 is placed between the first side forming plate 302 and the second side forming plate 306 on the slider fixture 202. Ultraviolet radiation or other methods are used to cure the adhesive. FIG. 3c illustrates a front view of the slider 110 and the formed slider fixture 202 after curing. After curing, the suspension may then be used to hold the slider 110 over a magnetic disk.

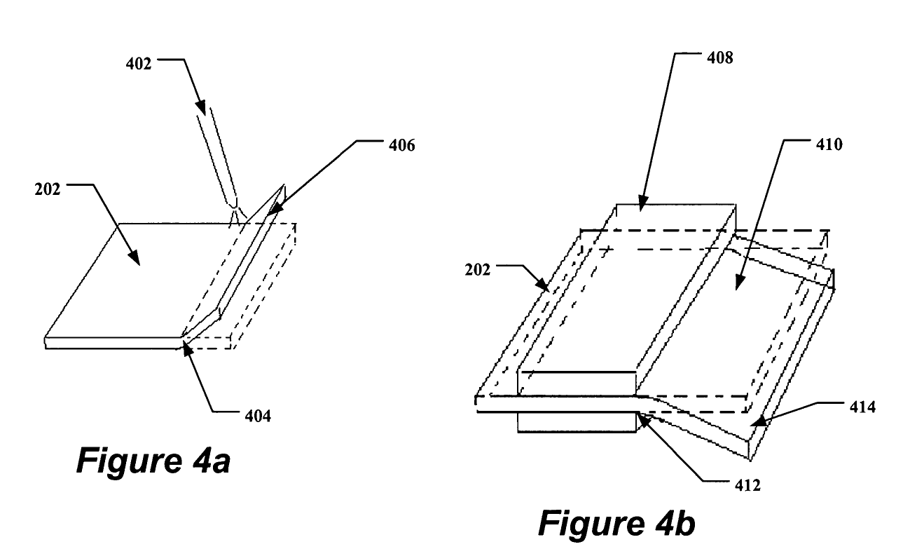

FIG. 4 illustrates alternate embodiments for creating the formed slider fixture. As shown in FIG. 4a, a laser 402 is used to bend 404 a stainless steel tongue 202 to create a forming plate 406. Alternatively, as shown in FIG. 4b, a machining tool 408 holds a slider fixture 202 in place while an applied force 410 creates a bend 412 resulting in a forming plate 414.

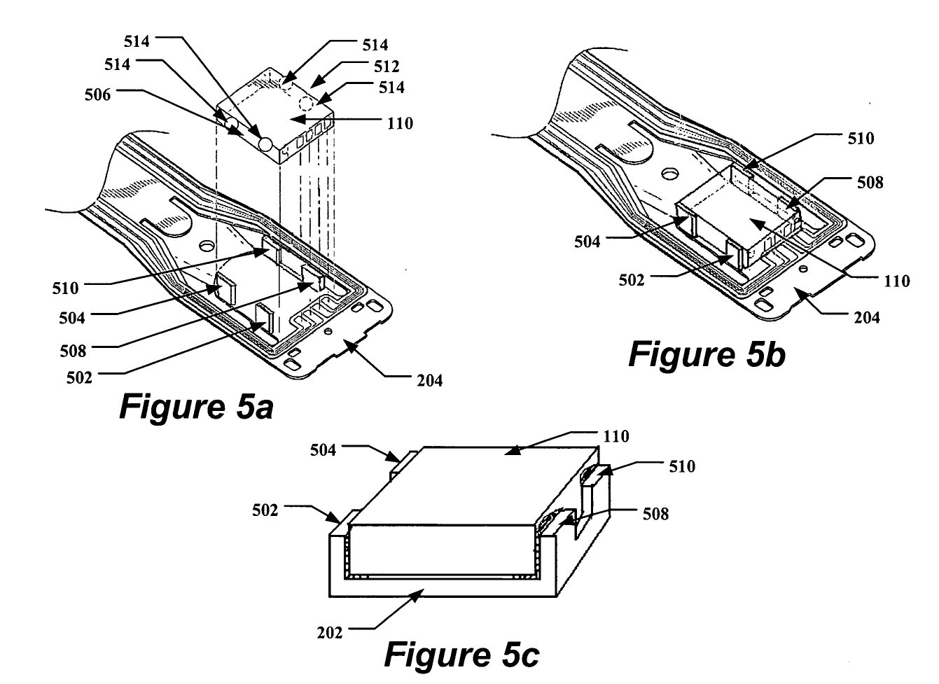

FIGS. 5a-c illustrate an alternate embodiment of a formed slider fixture. As shown in FIG. 5a, a slider fixture 202 has a first side forming plate 502 and a second side forming plate 504 formed to partially cover a first side surface 506 of the slider 110. For the purposes of this description, a forming plate partially covers a surface when the plate covers the surface for part of the horizontal length of the surface, as first side forming plate 502 and the second side forming plate 504 partially covers first side surface 506 in FIG. 5. A third side forming plate 508 and a fourth side forming plate 510 is formed to partially cover a second side surface 512 of the slider 110. For the purposes of this description, a forming plate partially covers a surface when the plate covers the surface for part of the horizontal length of the surface, as first side forming plate 502 partially covers first side surface 506 in FIG. 5. Two partial dots 514 of adhesive are applied to the first side surface 506 and second side surface 512 of the slider 110. The adhesive is an epoxy or a different adhesive material. As shown in FIG. 5b, the slider 110 is placed between the first side forming plate 502 and the second side forming plate 504 and the third side forming plate 508 and the fourth side forming plate 510 on the slider fixture 202. Ultraviolet radiation or other methods then cure the adhesive. FIG. 5c illustrates a front view of the slider 110 and the formed slider fixture 202 after curing.

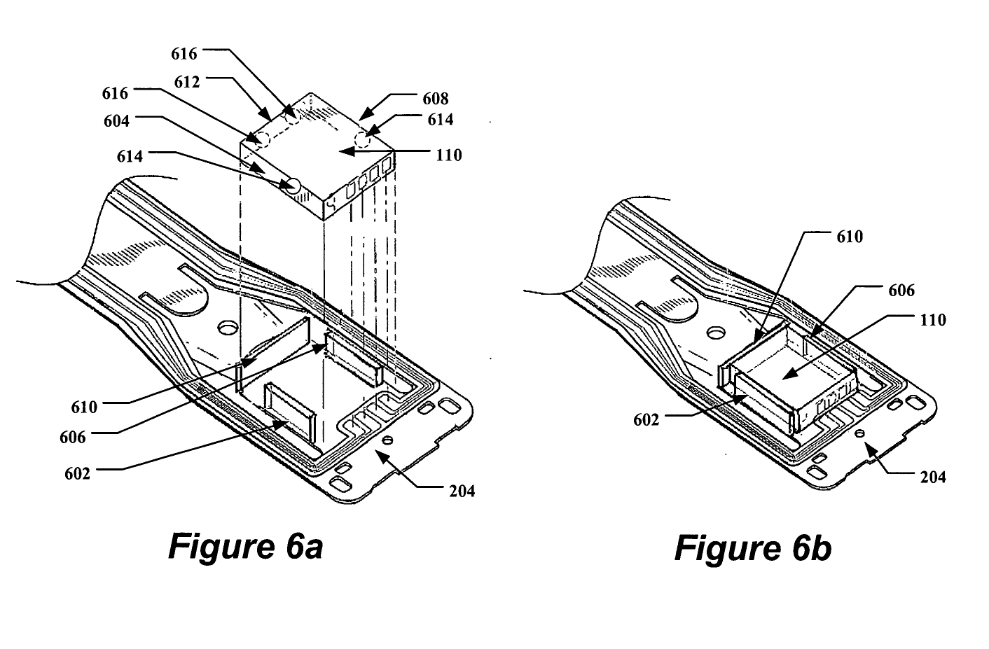

FIGS. 6a-b illustrate a further embodiment of a formed slider fixture. As shown in FIG. 6a, a slider fixture 202 has a first side forming plate 602 formed to partially cover a first side surface 604 of the slider 110. A second side forming plate 606 is formed to partially cover a second side surface 608 of the slider 110. A third forming plate 610 is formed to cover a third surface 612 of the slider 110. A partial dot 614 of adhesive is applied to the first side surface 604 and second side surface 608 of the slider 110. Two partial dots 616 of adhesive are applied to the third surface 612 of the slider 110. The adhesive is an epoxy or a different adhesive material. As shown in FIG. 6b, the slider 110 is placed between the first side forming plate 602, the second side forming plate 606, and the third forming plate 610 on the slider fixture 202. Ultraviolet radiation or other methods then cure the adhesive.

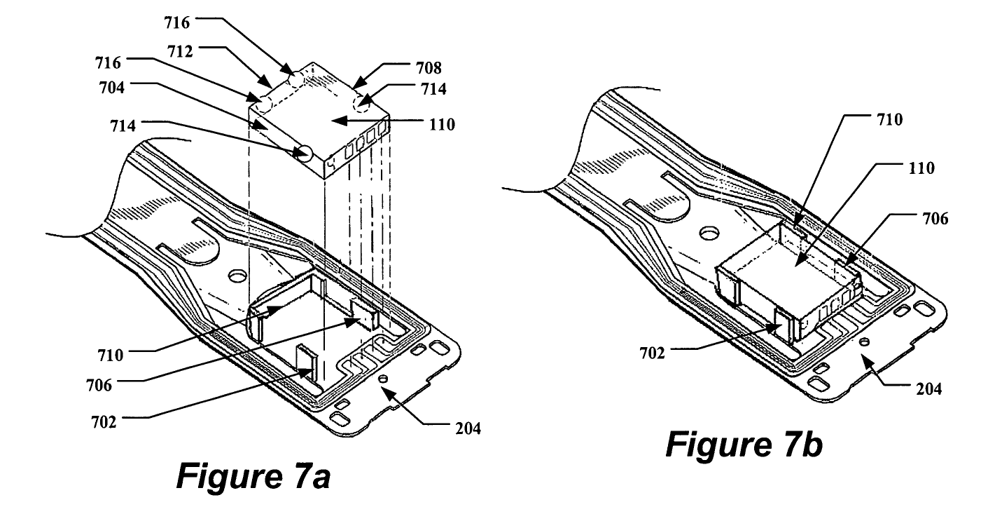

FIGS. 7a-b illustrate a further embodiment of a formed slider fixture. As shown in FIG. 7a, a slider fixture 202 has a first side forming plate 702 formed to partially cover a first side surface 704 of the slider 110. A second side forming plate 706 is formed to partially cover a second side surface 708 of the slider 110. A U-shaped forming plate 710 is formed to cover a third surface 712 of the slider 110 and to partially cover the first side surface 704 and the second side surface 708. A partial dot 714 of adhesive is applied to the first side surface 704 and second side surface 708 of the slider 110. Two partial dots 716 of adhesive are applied to the third surface 712 of the slider 110. The adhesive is an epoxy or a different adhesive material. As shown in FIG. 7b, the slider 110 is placed between the first side forming plate 702, the second side forming plate 706, and the U-shaped forming plate 710 on the slider fixture 202. Ultraviolet radiation or other methods then cure the adhesive.

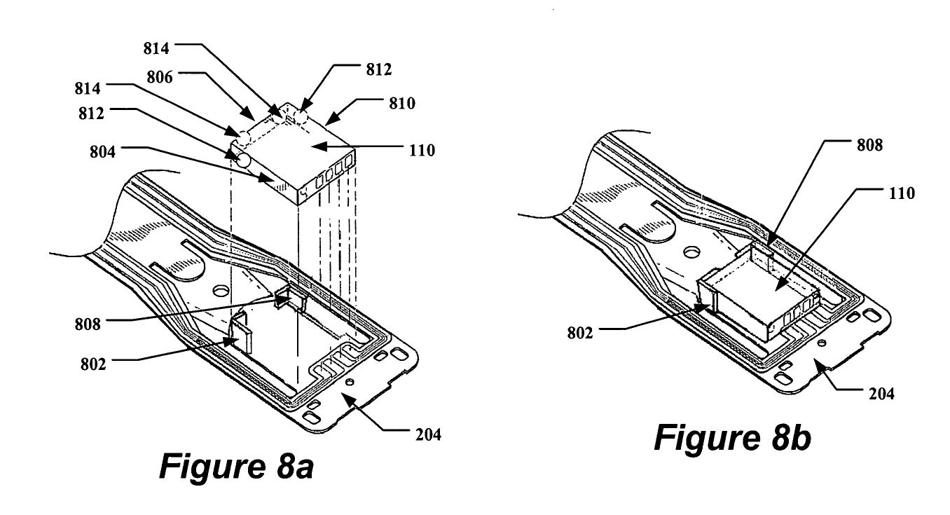

FIGS. 8a-b illustrate a further embodiment of a formed slider fixture. As shown in FIG. 8a, a slider fixture 202 has a first L-shaped forming plate 802 formed to partially cover a first side surface 804 and a third surface 806 of the slider 110. A second L-shaped forming plate 808 is formed to partially cover a second side surface 810 and a third surface 806 of the slider 110. A partial dot 812 of adhesive is applied to the first side surface 804 and second side surface 810 of the slider 110. Two partial dots 814 of adhesive are applied to the third surface 806 of the slider 110. The adhesive is an epoxy or a different adhesive material. As shown in FIG. 8b, the slider 110 is placed between the first L-shaped forming plate 802 and the second L-shaped forming plate 808 on the slider fixture 202. Ultraviolet radiation or other methods then cure the adhesive.

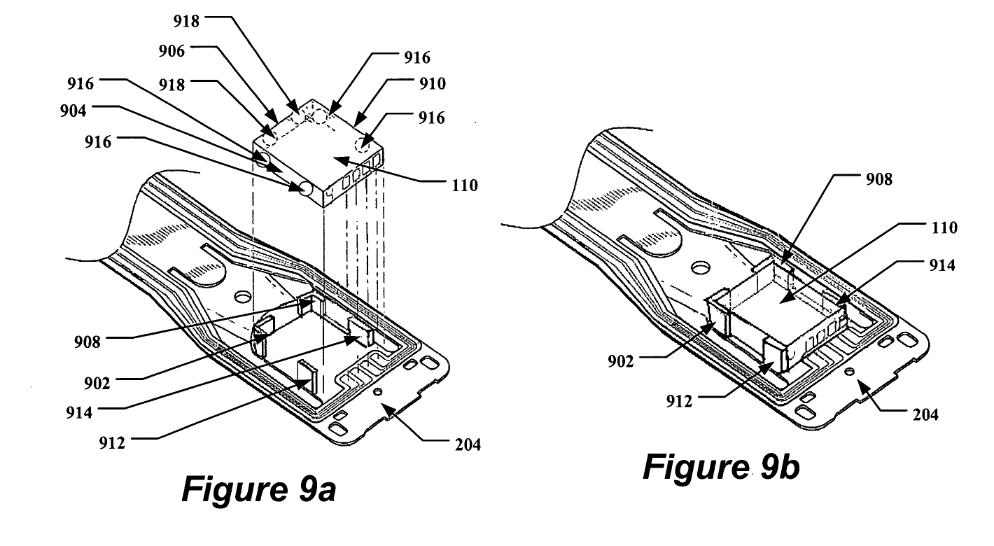

FIGS. 9a-b illustrate a further embodiment of a formed slider fixture. As shown in FIG. 9a, a slider fixture 202 has a first L-shaped forming plate 902 formed to partially cover a first side surface 904 and a third surface 906 of the slider 110. A second L-shaped forming plate 908 is formed to partially cover a second side surface 910 and a third surface 906 of the slider 110. A first side forming plate 912 is formed to partially cover the first side surface 904 of the slider 110. A second side forming plate 914 is formed to partially cover the second side surface 910 of the slider 110. Two partial dots 916 of adhesive are applied to the first side surface 904 and second side surface 910 of the slider 110. Two partial dots 918 of adhesive are applied to the third surface 906 of the slider 110. The adhesive is an epoxy or a different adhesive material. As shown in FIG. 9b, the slider 110 is placed between the first L-shaped forming plate 902 and the first side forming plate 912 and the second L-shaped forming plate 908 and the second side forming plate 914 on the slider fixture 202. Ultraviolet radiation or other methods then cure the adhesive.

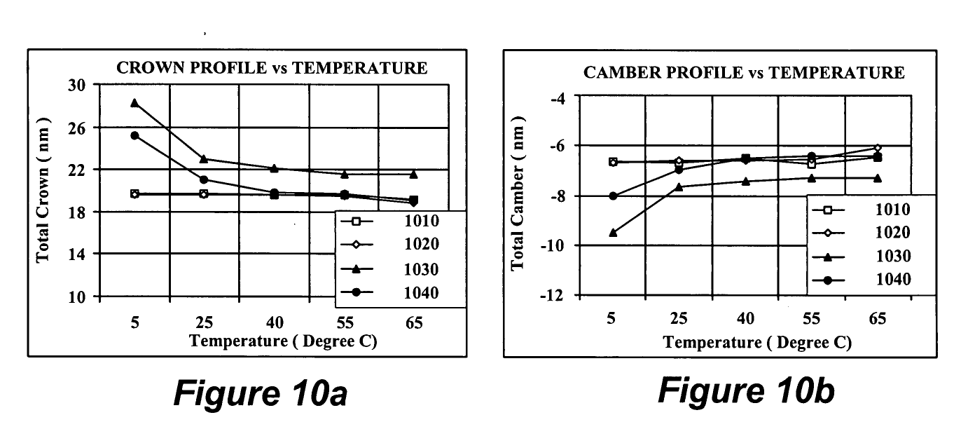

FIGS. 10a-b illustrate in a graph the testing result of the HGA profile change between the partial potting used with the formed slide-fixture and the full potting used in the prior art. FIG. 10a graphs the total crown, or concavity, of the slider against the temperature in degrees Celsius. A first partial potting 1010 and a second partial potting 1020 were tested, as were a first full potting 1030 and a second full potting 1040, with the partial pottings shown to have less variation as the temperature changed. FIG. 10b graphs the total camber, or convexity, of the slider against the temperature in degrees Celsius. Again, a first partial potting 1010 and a second partial potting 1020 were tested, as were a first full potting 1030 and a second full potting 1040, with the partial pottings shown to have less variation as the temperature changed.

1. A suspension assembly, comprising:
a suspension to hold a slider above a data storage medium; and
a slider fixture formed on the suspension to couple with portions of at least two surfaces of the slider other than a surface facing the data storage medium having a set of connecting pads; and
an adhesive substance is applied to the portions between the slider and the slider fixture to couple the slider to the slider fixture.

2. The suspension assembly of claim 1, wherein the adhesive substance is applied as a partial dot on the portion between the slider and the slider fixture.

3. The suspension assembly of claim 1, wherein the slider fixture has a first side forming plate formed to cover a first side surface of the slider and a second side forming plate formed to cover a second side surface of the slider.

4. The suspension assembly of claim 1, wherein the slider fixture has a first side forming plate formed to partially cover a first side surface of the slider and a second side forming plate formed to partially cover a second side surface of the slider.

5. The suspension assembly of claim 1, wherein the slider fixture has a third forming plate formed to cover a side surface opposite the surface having connecting pads.

6. The suspension assembly of claim 1, wherein the slider fixture has a U-shaped forming plate formed to cover a third side surface of the slider and to partially cover a first side surface and a second side surface of the slider.

7. The suspension assembly of claim 1, wherein the slider fixture has a first L-shaped forming plate formed to partially cover both a first side surface and a third side surface of the slider and a second L-shaped forming plate formed to partially cover both a second side surface and a third side surface of the slider.

8. A magnetic disk drive, comprising:
a data storage medium to store data;
a slider which has a read/write head;
a suspension to hold a slider above a data storage medium;
a slider fixture formed on suspension to couple with portions of at least two surfaces of the slider other than a surface facing the data storage medium or having a set of connecting pads;
an adhesive substance is applied to the portions between the slider and the slider fixture to couple the slider to the slider fixture; and
a controller to control movement of the suspension and operation of the read/write head.

9. The magnetic disk drive of claim 8, wherein the adhesive substance is applied as a partial dot on the portion between the slider and the slider fixture.

10. The magnetic disk drive of claim 8, wherein the slider fixture has a first side forming plate formed to cover a first side surface of the slider and a second side forming plate formed to cover a second side surface of the slider.

11. The magnetic disk drive of claim 8, wherein the slider fixture has a first side forming plate formed to partially cover a first side surface of the slider and a second side forming plate formed to partially cover a second side surface of the slider.

12. The magnetic disk drive of claim 8, wherein the slider fixture has a third forming plate formed to cover a third side surface opposite the surface having connecting pads.

13. The magnetic disk drive of claim 8, wherein the slider fixture has a U-shaped forming plate formed to cover a third side surface of the slider and to partially cover a first side surface and a second side surface of the slider.

14. The magnetic disk drive of claim 8, wherein the slider fixture has a first L-shaped forming plate formed to partially cover both a first and a third side surface of the slider and a second L-shaped forming plate formed to partially cover both a second and a third side surface of the slider.

15. A method, comprising:
forming a slider which has a read/write head;
forming a suspension to hold a slider;
forming a circuit on the suspension to connect electrically with the slider;
forming a slider fixture on the suspension to couple with portions of at least two surfaces of the slider other than a surface facing the data storage medium or having a set of connecting pads;
coupling the slider with the slider fixture by applying an adhesive substance to the slider or the suspension; and
electrically connecting the circuit with the slider.

16. The method of claim 15, further comprising applying the adhesive substance as a partial dot on at least one side surface of the slider or on suspension.

17. The method of claim 15, further comprising:
forming a first side forming plate of the slider fixture to partially cover a first side surface of the slider; and
forming a second side forming plate of the slider fixture to partially cover a second side surface of the slider.

18. The method of claim 15, further comprising forming a third side forming plate formed to cover a side surface opposite a surface having connecting pads.

19. The method of claim 15, further comprising forming a U-shaped forming plate to surround a third side surface of the slider and to partially cover a first side surface and a second side surface of the slider.

20. The method of claim 15, further comprising:
forming a first L-shaped forming plate to partially cover both a first and a third side surface of the slider; and
forming a second L-shaped forming plate to partially cover both a second and a third side surface of the slider.
